(19) United States
(12) Patent Application Publication
(10) Pub. No.: US 2019/0245887 A1
(43) Pub. Date: Aug. 8, 2019

(54) NETWORK PROTOCOL MODIFICATION SYSTEMS FOR MITIGATING ATTACKS

(71) Applicant: Viesoft, Inc., San Francisco, CA (US)

(72) Inventor: Anthony Vierra, San Francisco, CA (US)

(21) Appl. No.: 16/271,123

(22) Filed: Feb. 8, 2019

Related U.S. Application Data
(60) Provisional application No. 62/628,085, filed on Feb. 8, 2018.

(51) Int. Cl. H04L 29/06

(52) U.S. Cl. CPC H04L 63/1458; H04L 2463/141; H04L 2463/144; H04L 63/1416

(57) ABSTRACT

In a particular embodiment, a network protocol modification system is configured to identify a malicious attack on a particular computing system, and modify a protocol (e.g., Border Gateway Protocol) that dictates a path of network traffic to the particular computing system. The system may, for example, modify a protocol (e.g., Border Gateway Protocol) that dictates the path of network traffic to the particular computing system for: (1) all network traffic; (2) any network traffic from one or more particular sources; and/or (3) any other suitable combination of traffic. In some embodiments, the system may interface with one or more ISP or other systems in order to propagate network protocol updates. In particular embodiments, the system is particularly configured to mitigate one or more DDoS attacks against a particular target network or service.

### CROSS-REFERENCE TO RELATED APPLICATIONS

This application claims priority from U.S. Provisional Patent Application Ser. No. 62/628,085, filed Feb. 8, 2018, entitled “Network Protocol Modification Systems for Mitigating Attacks,” the disclosure of which is incorporated by reference herein in its entirety.

### BACKGROUND

Malicious entities, individuals, or others may attempt to disrupt online services by making them unavailable through distributed denial of service (DDoS) and other network-based attacks. Accordingly, there is a need for systems and methods for mitigating such disruption.

### SUMMARY

A network protocol modification system, according to particular embodiments, comprises one or more computing devices implementing a network-based attack mitigation service. In various embodiments, each of the one or more computing devices comprise at least one computer processor and memory. In any embodiment described herein, the network protocol modification system may be configured for: (A) monitoring network traffic at a target server; (B) detecting, based at least in part on the network traffic, a network attack on the particular target server, wherein the network attack is directed to a combination of network addresses utilized by the target server; (C) identifying one or more sources of the network attack, the one or more sources having one or more source network addresses; and (D) modifying routing of network transmissions from the one or more sources to the target server.

In various embodiments, the network protocol modification system is configured to modify routing of network transmissions from the one or more sources to the target server by: (A) generating at least one network protocol modification packet based at least in part on the network attack; and (B) transmitting the at least one network protocol modification packet to at least one router in communication with at least one of the one or more computing devices. In various embodiments, the at least one router is part of one or more internet server provider systems with which the one or more computing devices are in networked communication in order to facilitate an update of one or more network routing protocols by the one or more ISP systems. In particular embodiments, the at least one network protocol modification packet comprises a Border Gateway Protocol (BGP) update.

A computer-implemented network routing protocol modification method, according to various embodiments, comprises: (A) detecting, by a network protocol modification system comprising one or more processors, a network attack on one or more computing devices, the network attack being directed to a combination of network addresses utilized by the one or more computing devices; (B) identifying, by a network protocol modification system comprising one or more processors, based at least in part on the network attack, one or more source network addresses that are a source of the network attack; (C) providing, by one or more processors, a networked communications link between the network protocol modification system and an Internet Service Provider (ISP) system, the ISP system comprising an autonomous system (AS) comprising at least one node; and (D) mitigating the network attack, by a network protocol modification system comprising one or more processors.

In particular embodiments, the computer-implemented network routing protocol modification method comprises mitigating the network attack by: (A) generating a BGP packet configured to modify how data addressed to the combination of network addresses is routed, the BGP packet defining routing instructions for malicious network traffic originating from the one or more source network addresses and having a destination address of one of the combination of network addresses utilized by the one or more computing devices; and (B) transmitting the BGP packet to the autonomous system (AS) via the networked communications link. In some embodiments, the routing instructions comprise an instruction to drop the malicious network traffic.

A network protocol modification system, according to various embodiments, comprises one or more computing devices implementing a network-based network routing protocol modification service. In any embodiment described herein, the one or more computing devices may comprise at least one computer processor and computer memory. In particular embodiments, the network protocol modification system is configured for: (A) identifying one or more sources of unwanted network traffic, the one or more sources having one or more source network addresses; (B) providing a networked communications link between the network protocol modification system and an Internet Service Provider (ISP) system, the ISP system comprising an autonomous system (AS) comprising at least one node; and (C) modifying routing of network transmissions from the one or more source network addresses to one or more destination network addresses.

In any embodiment described herein, the network protocol modification system is configured to modify routing of network transmissions from the one or more source network addresses to one or more destination network addresses by: (A) generating at least one network protocol modification packet based at least in part on the unwanted network traffic, the at least one network protocol modification packet defining routing instructions for the unwanted traffic between the one or more source network addresses and the one or more destination network addresses; and (B) transmitting the at least one network protocol modification packet to the AS via the networked communications link for configuration of the at least one node. In some embodiments, the routing instructions comprise an instruction to drop the unwanted traffic. In various embodiments, the unwanted traffic comprises traffic originating from a host server or other location that is a frequent violator of one or more rights-holders' copyrights. In such embodiments, the system may be configured to provide a filter against copyrighted content for a particular geographic location (e.g., a location in which the copyright holder holds the copyright).

### BRIEF DESCRIPTION OF THE DRAWINGS

Various embodiments of a network protocol modification system are described below. In the course of this description, reference will be made to the accompanying drawings, which are not necessarily drawn to scale, and wherein:

FIG. 1 depicts a network protocol modification system according to particular embodiments.

FIG. 2 is a schematic diagram of a computer (such as the network protocol modification server 110, or one or more remote computing devices 150) that is suitable for use in various embodiments of the network protocol modification system shown in FIG. 1.

FIG. 3 is a flowchart showing an example of steps performed by a Network Protocol Modification Module according to particular embodiments.

FIGS. 4-7 depict exemplary illustrative network traffic flow diagrams.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

In particular embodiments, a network protocol modification system is configured to identify a malicious attack on a particular computing system (e.g., server, website, etc.), and modify a protocol (e.g., Border Gateway Protocol) that dictates a path of network traffic to the particular computing system. The system may, for example, modify a protocol that dictates the path of network traffic to the particular computing system for: (1) all network traffic; (2) any network traffic from one or more particular sources (e.g., one or more source network addresses); and/or (3) any other suitable combination of traffic. In particular embodiments, the system is particularly configured to mitigate one or more DDoS attacks against a particular target network or service.

For example, in various embodiments, the system is configured to mitigate one or more volumetric DDoS attacks, one or more TCP state-exhaustion DDoS attacks, one or more application layer DDoS attacks, and/or any other suitable type of DDoS attack originating from any suitable source or group of sources. In some embodiments, a volumetric DDoS attack may include, for example, any attempt to consume bandwidth either within a particular target network or service or between the particular network or service and one or more other networks (e.g., the internet). In particular embodiments, a TCP state-exhaustion DDoS attack may include, for example, any attempt to consume one or more connection state tables associated with one or more particular infrastructure components (e.g., load-balancers, firewalls, application servers, etc.) associated with a particular network or service. In other embodiments, an application layer DDoS attack may include any attempt to take down a site or service via a low traffic rate.

In particular embodiments, the network protocol modification system is configured to: (1) determine that a DDoS attack is occurring against a particular target (e.g., against one or more target network addresses); and (2) in response to determining that the attack is occurring, modify one or more routing protocols that dictate a path of network traffic to the particular target via at least one node (e.g., router, hub, switch, etc.). In various embodiments, the system is configured to modify the protocol by, for example, generating a BGP packet and transmitting the BGP packet to at least one router in communication with a network protocol modification system, where the BGP packet defines a route map, modifies a weight attribute of a particular route, directs the at least one router to drop particular traffic, etc. In particular embodiments, the system may be configured to identify one or more source Internet Protocol (IP) addresses for the attack, and push a BGP update (e.g., to one or more routers, one or more autonomous systems, etc.) to block all traffic from any router that receives traffic from the one or more source IP addresses that is destined for one or more IP addresses associated with the target. In this way, the system may be configured to cause malicious traffic to be dropped prior to reaching the target.

In particular embodiments, the network protocol modification system is configured to interface with (e.g., via one or more communication channels) one or more Internet Service Provider (ISP) systems to provide updated routing information based on identified malicious attacks (e.g., DDoS attacks) in order to at least partially mitigate an attack against a particular target. In this way, the system may be configured to provide updated routing information at the ISP level that will direct particular routers, nodes and other networking infrastructure to drop unwanted and malicious traffic as it identified at any point during routing from a source network address to a destination (e.g., target) network address.

Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

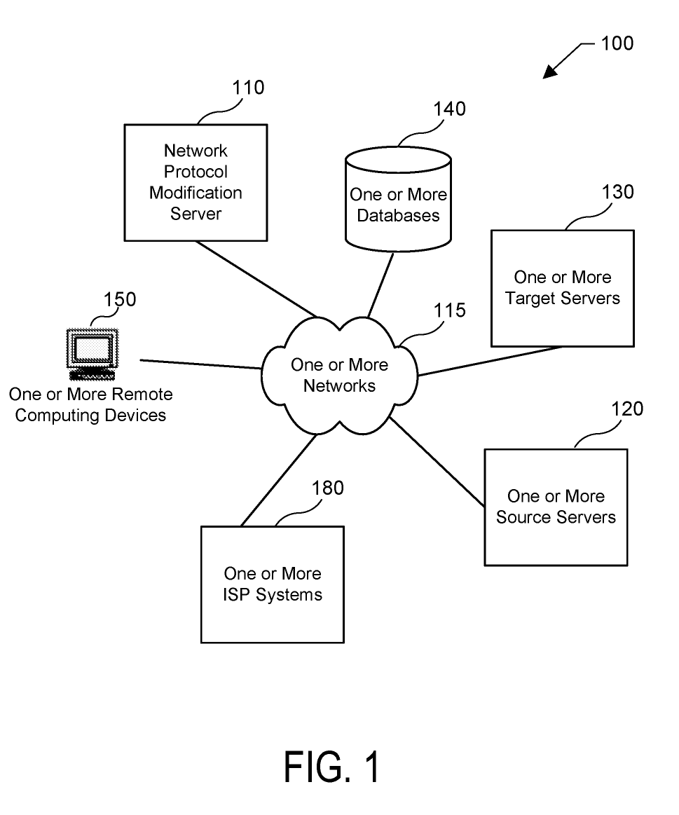

FIG. 1 is a block diagram of a Network Protocol Modification System 100 according to a particular embodiment. In various embodiments, the Network Protocol Modification System 100 is configured to modify a path of network traffic between one or more IP addresses by modifying a Border Gateway Protocol (BGP) of at least one router.

As may be understood from FIG. 1, the Network Protocol Modification System 100 includes one or more computer networks 115, a Network Protocol Modification Server 110, One or More Source Servers 120 (e.g., which may include one or more computing devices, servers, or other devices that serve as a source of a particular DDos attack), One or More Target Servers 130 (e.g., which may include one or more servers that are the target of the particular DDos attack), One or More Databases 140 or other data structures, one or more remote computing devices 150 (e.g., a desktop computer, laptop computer, tablet computer, smartphone, etc.), and One or More ISP Systems 180. In particular embodiments, the one or more computer networks 115 facilitate communication between the Network Protocol Modification Server 110, One or More Source Servers 120, One or More Target Servers 130, One or More Databases 140 or other data structures, and one or more remote computing devices 150.

Although in the embodiment shown in FIG. 1, the Network Protocol Modification Server 110, One or More Source Servers 120, One or More Target Servers 130, One or More Databases 140 or other data structures, and one or more remote computing devices 150 are shown as separate servers, it should be understood that in other embodiments, one or more of these servers and/or computing devices may comprise a single server, a plurality of servers, one or more cloud-based servers, or any other suitable configuration of computing devices or servers (e.g., which may include one or more processors and/or computer memory).

In particular embodiments, the Network Protocol Modification Server 110 may be configured to interface with a particular Internet Server Provider (ISP) system (e.g., the One or More ISP Systems 180) to provide, transmit, and/or propagates network protocol modification packets and/or updates that are configured to modify the handling of network traffic (e.g., internet traffic) at the ISP level. In particular embodiments, the One or More ISP Systems 180 may comprise one or more nodes (e.g., redistribution points) such as, for example, one or more routers, one or more switches, one or more hubs, etc. In various embodiments, the One or More ISP Systems 180 may comprise an autonomous system or collection of autonomous systems. In other embodiments, the One or More ISP Systems 180 may comprise a point of presence or a plurality of points of presence (e.g., which may include one or more physical locations that store one or more physical components that make up the One or More ISP Systems 180).

The one or more computer networks 115 may include any of a variety of types of wired or wireless computer networks such as the Internet, a private intranet, a public switch telephone network (PSTN), or any other type of network. The communication link between One or More Target Servers 130 and the One or More Source Servers 120 may be, for example, implemented via a Local Area Network (LAN) or via the Internet (e.g., via a series of routers in a path dictated by a particular Border Gateway Protocol). In other embodiments, the One or More Databases 140 may be stored either fully or partially on any suitable server or combination of servers described herein.

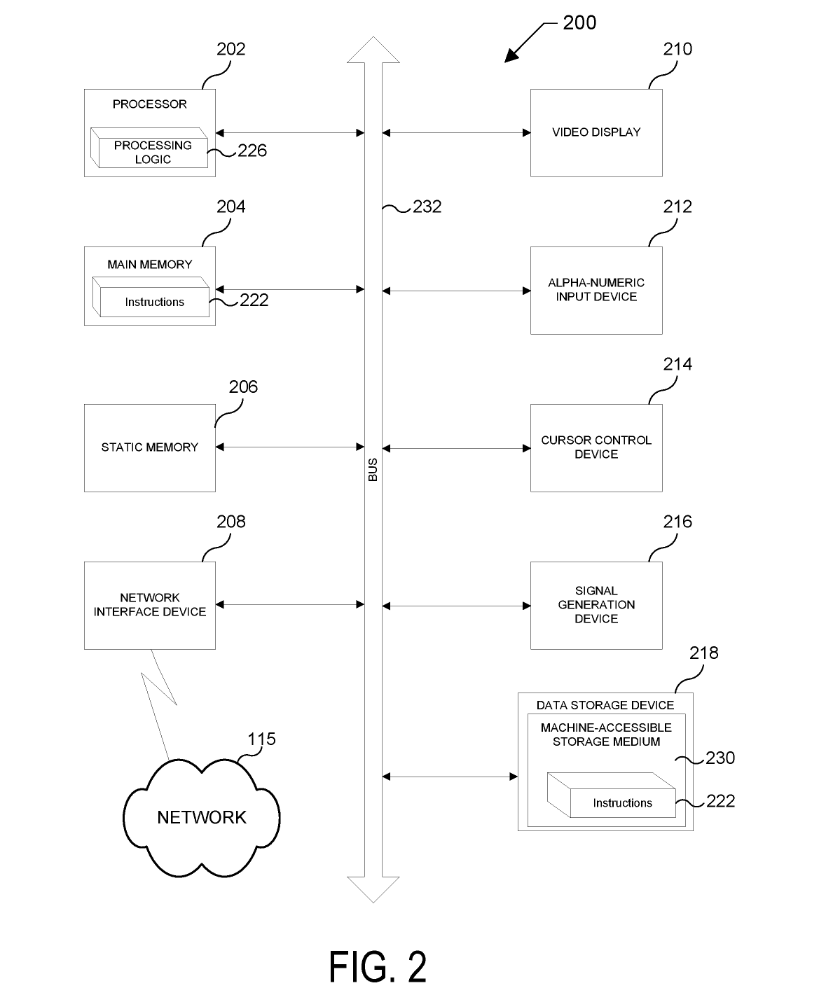

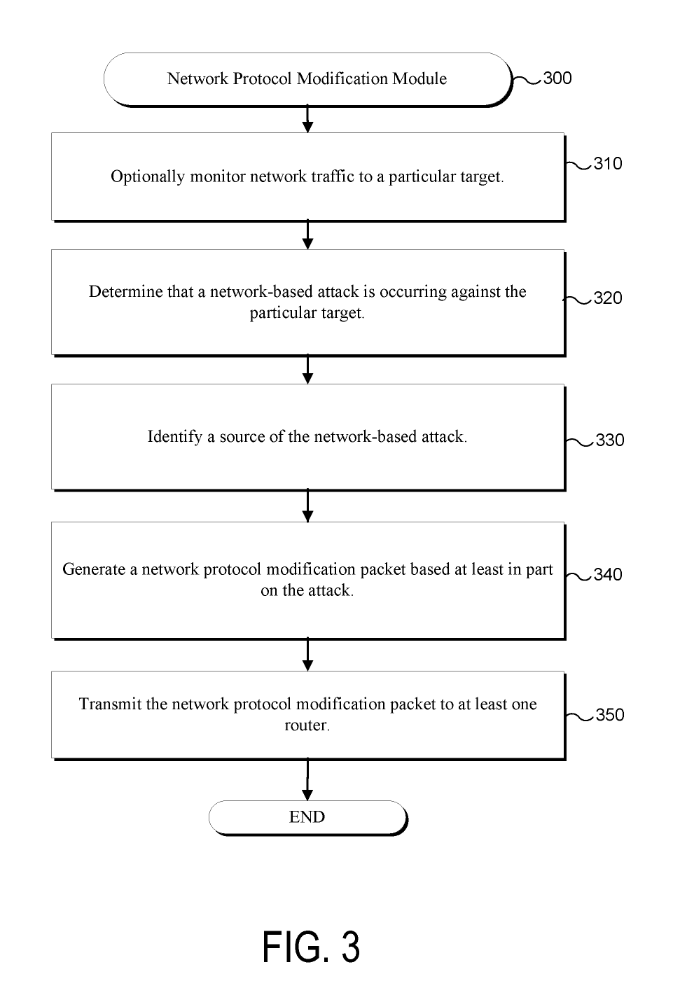

FIG. 2 illustrates a diagrammatic representation of a computer 200 that can be used within the Data Model Generation and Population System 100, for example, as a client computer (e.g., one or more remote computing devices 130 shown in FIG. 1), or as a server computer (e.g., Data Model Generation Server 110 shown in FIG. 1). In particular embodiments, the computer 200 may be suitable for use as a computer within the context of the Data Model Generation and Population System 100 that is configured to generate a data model and map one or more relationships between one or more pieces of data that make up the model.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a network protocol modification system may be implemented in the context of any network attack mitigation system (e.g., or any other system described herein). For example, the network protocol modification system may be implemented to identify and mitigate DDoS and other network-based attacks against particular servers, websites, services, and other systems. Various aspects of the system's functionality may be executed by certain system modules, including a Network Protocol Modification Module 300. This module is discussed in greater detail below. Although the Network Protocol Modification Module 300 is presented as a series of steps, it should be understood in light of this disclosure that various embodiments, a system executing the Network Protocol Modification Module 300 may perform the steps described below in an order other than in which they are presented. In still other embodiments, the Network Protocol Modification Module 300 may omit certain steps described below. In still other embodiments, the system, when executing the Network Protocol Modification Module 300, may perform steps in addition to those described.

### Network Protocol Modification Module

In particular embodiments, a Network Protocol Modification Module 300 is configured to: (1) determine that a network-based attack (e.g., DDoS attack) is occurring against a particular target; (2) identify a source of the network-based attack; (3) generate a network protocol modification packet (e.g., or other network routing protocol modification instruction); and (4) transmit the network protocol modification packet to at least one router responsible for routing network traffic from the source to the target. In particular embodiments, the system is configured to specifically generate and propagate, to at least one node, a BGP update in the form of at least one BGP packet for modifying BGP to drop network traffic originating from the source that is destined for the target.

When executing the Network Protocol Modification Module 300, the system begins, at Step 310, by optionally monitoring network traffic to a particular target. In particular embodiments, the particular target may include, for example: (1) one or more web servers; (2) one or more networks; (3) one or more systems; and/or (4) any other target which may be a potential victim of a network-based attack. In particular embodiments, the system is configured to monitor network traffic to the particular target substantially automatically. For example, in various embodiments, the system may be configured to: (1) monitor requests received from one or more particular IP addresses over a particular period of time (e.g., identify that a particular IP address has made more than X requests over Y seconds, where X and Y above a certain value may indicate a potential attack is occurring); (2) monitor time to live (TTL) for the target; (3) review access logs for the particular target; (4) monitor the particular target for 503 responses (e.g., monitor one or more systems associated with the particular target for instances in which the system returns a 503 or service unavailable response), etc.

In various embodiments, the network protocol modification system may perform one or more of these monitoring steps as an optional step as part of a process for mitigating network-based attacks. In such embodiments, the system may, for example, be configured to receive network traffic monitoring data based on analysis performed by one or more third party services, performed by the particular target, etc. In this way, the system may be configured to perform the additional steps described below in response to receiving an indication that a network-based attack may be occurring against the particular target.

Continuing to Step 320, by determining that a network-based attack (e.g., DDoS attack) is occurring against particular target. In particular embodiments, the system is configured to determine that the network-based attack is occurring based at least in part on the monitored network traffic described above. The system may, for example, be configured to determine that a network-based attack is occurring based at least in part on: (1) the particular target receiving more than a particular number of requests in a particular time period from a particular IP address (e.g., one or more particular IP addresses); (2) the particular target returning more than a particular number of 503 events; (3) determining that a TTL (time to live) time out has occurred; (4) one or more log management system solutions; and/or (5) any other suitable information gleaned as a result of monitoring network traffic to the particular target.

In other embodiments, the system is configured to determine that a network-based attack is occurring against the particular target in response to receiving a request from the particular target (e.g., or a third party) to mitigate the attack. In such embodiments, the particular target (e.g., or a third party on behalf of the particular target) may monitor web traffic to the particular target to identify potential network-based attacks. The particular target (e.g., or a third party on behalf of the particular target) may then notify the network protocol modification system that a DDoS attack is occurring and requires mitigation.

Continuing to Step 330, the system is configured to identify a source of the network-based attack. In particular embodiments, the system is configured to identify a plurality of sources of the network-based attack (e.g., a botnet, a plurality of computing devices, etc.). As may be understood by one skilled in the art, a network-based attack (e.g., such as a DDoS attack) may utilize a plurality of computing devices, bots, botnets, servers, virtual machines, etc. in order to facilitate the attack against a particular target. As such, the system may identify as many sources associated with the attack as possible in order to properly mitigate it.

As such, in various embodiments, the system may be configured to identify that the attack originates: (1) from a particular geographic location (e.g., based on one or more IP addresses of one or more computing devices that serve as a source of the attack); (2) from a particular domain; (3) from a particular network; (4) via a particular internet service provider (ISP); and/or (5) from any other suitable source. In particular embodiments, for example, a particular attack may have a source that is ISP-wide (e.g., a country-specific ISP may launch an attack against one or more services in a foreign country for political purposes). In other embodiments, a source of the attack may include an individual or group of individuals utilizing a plurality of computing devices to target a particular site, service, server, etc.

In various embodiments, the source of the attack may include one or more IP addresses or other network addresses, one or more MAC addresses, or any other unique identifier which the system may use to filter, block, or otherwise identify the particular source of the attack.

Next, at Step 340, the system is configured to generate a network protocol modification packet based at least in part on the attack. The system may, for example, generate a network protocol modification packet that identifies one or more of: (1) a source of the attack (e.g., one or more network addresses associated with the source of the attack); (2) a target of the attack (e.g., one or more network addresses or a combination of network addresses associated with a target of the attack; (3) one or more instructions related to internet traffic associated with the attack (e.g., one or more routing instructions, one or more instructions to drop the traffic, etc.); (4) a particular type of data transmitted via one or more packets associated with the attack (e.g., any suitable portion of a particular file made up by the one or more packets, such as copyrighted content, etc.); and/or (5) any other suitable data related to the modification of a network protocol related to network traffic that originates from the source of the attack which may, in various embodiments, have a destination of the target.

In some embodiments, the network protocol modification packet comprises one or more BGP protocol updates for transmission to one or more nodes (e.g., one or more routers in a particular autonomous system, one or more routers across a plurality of autonomous system, etc.). In various embodiments, the one or more BGP protocol updates are configured to modify the handling of network traffic at the router level (e.g., by a particular autonomous system, by a particular router within an autonomous system, etc.). In this way, the system may be configured to generate a network protocol modification packet that is configured to modify routing information for particular traffic handled at the router level. As such, the system may be configured to propagate updated routing information for particular network traffic across a plurality of autonomous systems (e.g., a plurality of autonomous systems for which network traffic routing is dictated by BGP).

In various embodiments, the network protocol modification packet is configured to update a particular routing table (e.g., BGP routing table) for one or more particular routers. In particular embodiments, the network protocol modification packet is configured to transmit the one or more BGP protocol updates to one or more BGP peers of a particular router. In this way, the system may be configured to generate a network protocol modification packet that is configured to propagate across a plurality of routers, nodes, and/or autonomous systems such that a plurality of nodes through which network traffic that is part of the malicious attack may be configured to identify attack traffic and drop the traffic prior to the traffic reaching the target.

Although network protocol modification is described above in the context of the generation of a network protocol modification packet (e.g., BGP packet), it should be understood that various other embodiments may utilize any other suitable technique for providing one or more routing instructions to one or more nodes, routers, autonomous systems, etc.

Next, at Step 350, the system is configured to transmit the network protocol modification packet to at least one router. In particular embodiments, the at least one router comprises an internal BGP peer within a particular autonomous system (e.g., an internal peer within an autonomous system associated with the network protocol modification system described above, an internal peer to one or more routers associated with the target of the attack, etc.). In other embodiments, the at least one router comprises an external BGP peer within a particular external autonomous system.

In particular embodiments, the Network Protocol Modification Server 110 may be configured to interface with a particular Internet Server Provider (ISP) system (e.g., the One or More ISP Systems 180) to provide, transmit, and/or propagates network protocol modification packets and/or updates that are configured to modify the handling of network traffic (e.g., internet traffic) at the ISP level. In particular embodiments, the One or More ISP Systems 180 may comprise one or more nodes (e.g., redistribution points) such as, for example, one or more routers, one or more switches, one or more hubs, etc. In various embodiments, the One or More ISP Systems 180 may comprise an autonomous system or collection of autonomous systems. In other embodiments, the One or More ISP Systems 180 may comprise a point of presence or a plurality of points of presence (e.g., which may include one or more physical locations that store one or more physical components that make up the One or More ISP Systems 180).

In any embodiment described herein, the network protocol modification system is configured to interface with (e.g., via one or more communication channels) one or more Internet Service Provider (ISP) systems to provide updated routing information based on identified malicious attacks (e.g., DDoS attacks) in order to at least partially mitigate an attack against a particular target. In this way, the system may be configured to provide updated routing information at the ISP level that will direct particular routers, nodes and other networking infrastructure of the ISP to drop unwanted and malicious traffic as it is identified at any point during routing from a source network address to a destination (e.g., target) network address.

### Illustrative Network Protocol Modification Examples

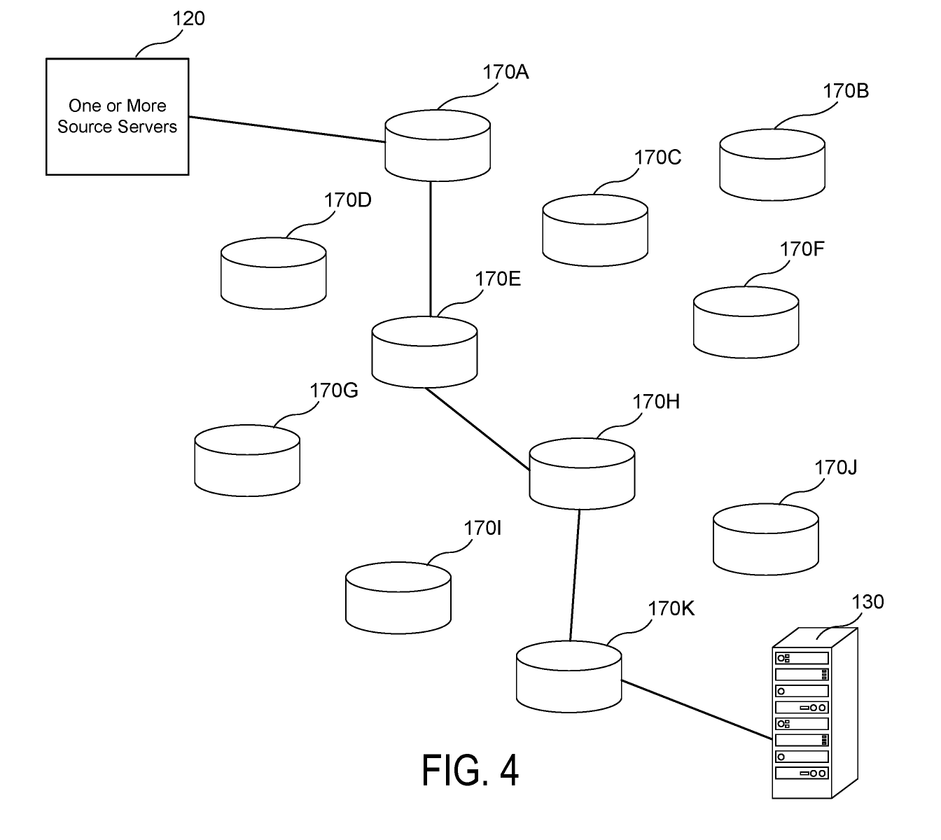

FIGS. 4-7 depict exemplary network traffic routing diagrams that illustrate an exemplary use of network protocol modification (e.g., via a network protocol modification system) to mitigate a network-based attack against a target server 130. As may be understood from these figures, a particular network-based attack may be routed from One or More Source Servers 120 through a plurality of nodes 170A-K (e.g., one or more routers, one or more points of presence, one or more autonomous systems, one or more switches, one or more hubs, or any other suitable networking devices, access points, etc. though which network traffic may be routed) to a target 130. The network traffic may, for example, overwhelm the target and cause slowdowns and other issues that may hinder or prevent legitimate network traffic to the target 130.

FIG. 4 depicts an exemplary network-based attack where traffic (e.g., malicious traffic) is routed from the One or More Source Servers 120 through a first node 170A to a fifth node 170E to an eighth node 170H to an eleventh node 170k to the target server 130. As may be understood in light of this disclosure, the routing of the malicious traffic may be determined at the node level using Border Gateway Protocol. Although in the example shown in this figure, each node 170A-K is illustrated as an individual node, it should be understood that in other examples, any particular node or combination of nodes (e.g., routers) shown may make up a particular autonomous system. As such, any particular node 170A-K shown in FIG. 4 may have either an internal BGP peer or external BGP peer relationship with any other node 170A-K shown.

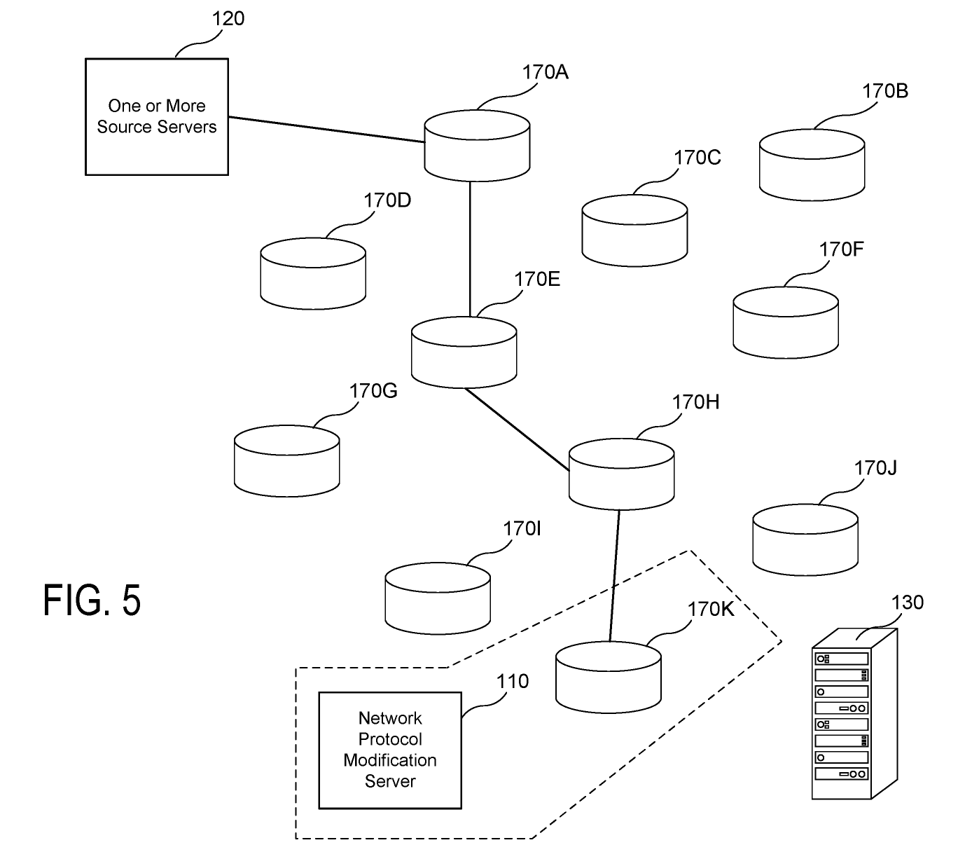

In particular other embodiments, each particular node 170A-K shown if FIG. 4 (e.g., and FIGS. 5-7) may depict and/or represent a collection of nodes, a particular autonomous system, a particular collection of autonomous systems, a particular ISP (e.g., which may comprise one or more autonomous systems, a plurality of routing and other network routing systems, etc.), etc.

Continuing to FIG. 5, the system may be configured to identify the network-based attack (e.g., using any suitable technique described herein), and mitigate the attack by modifying one or more network protocols associated with the routing of internet traffic from the One or More Source Servers 120 to the target server 130. In the example shown in FIG. 5, the system is configured to generate a network protocol modification packet (e.g., or other network routing instruction) and transmit the packet to at least one router (e.g., the eleventh node 170K). As discussed above, the network protocol modification packet may comprise updated routing instructions that include dropping traffic having a source of the One or More Source Servers 120 and a destination of the target server 130. The network protocol modification packet may identify the One or More Source Servers 120 and/or the target server by, for example: (1) IP address (e.g., or IP addresses); (2) MAC address (e.g., or MAC addresses); and/or (3) any other suitable network address that a router or other node may use to identify the source and target based on information in a particular data packet that the router or other node is routing.

The system may, for example, be configured to transmit the packet (e.g., which may contain one or more BGP updates as described above) to one or more routers that are in networked communication with a Network Protocol Modification Server 110 (e.g., one or more peer routers). In the example shown in this figure, the eleventh node 170K may comprise the One or More ISP Systems 180 described above. As may be understood in light of this disclosure, the Network Protocol Modification Server 110 (e.g., or other network protocol modification system) may be configured to interface with One or More ISP Systems 180 to provide network-based attack mitigation services (e.g., and other network routing modification services). In this way, the system may be configured to enable modification at the ISP level of routing information for network traffic handled by any of a plurality of Internet Service Providers and other autonomous systems that interface with the network protocol modification system.

Because some nodes and other routing systems may not be configured to automatically apply BGP and other network updates from BGP peers (e.g., particularly from external BGP peers), it may be preferable to implement a network protocol modification system that integrates directly at the ISP level (e.g., or other internet backbone level) to at least partially ensure that autonomous systems and other high-traffic handling systems apply updates generated by the network protocol modification system in response to identified network-based attacks. Such integration may reduce a likelihood that a particular website or other attack target may be affected by an attack and also reduce a routing load on one or more autonomous systems and other nodes responsible for handling the malicious traffic (e.g., because the one or more nodes 170 can simply drop the identified malicious traffic).

In other embodiments, the system is configured to identify a particular router to transmit the packet to based at least in part on existing BGP routing information. The system may, for example, identify a particular node (e.g., 170K), router, or autonomous system that handles network traffic that makes up the network-based attack and transmit the packet containing the BGP update to the identified node 170K. In this way, the system may be configured to determine a route of the malicious traffic and cause the malicious traffic to be dropped along the route (e.g., at least by the particular node 170K). In various embodiments, as may be understood in light of this disclosure, the node 170K may then be configured to share the BGP update with one or more BGP peers (e.g., one or more internal or external BGP peers, which may, in turn, apply the BGP update). In this way, they system may be configured to cause a plurality of nodes 170K to update a BGP routing table or other routing information to include an instruction to drop network traffic from the source to the target.

As may be appreciated by one skilled in the art, because network traffic from a particular source to a particular destination (e.g., the target 130) may travel a plurality of different routes, the system may be configured to more effectively mitigate a particular network-based attack by propagating the network protocol modification (e.g., BGP update) to a greater number of nodes 170A-K that make up a potential path of the malicious network traffic. In this way, any particular node 170A-K that has applied the BGP update and through which the malicious traffic travels may drop the traffic.

In particular embodiments, the Network Protocol Modification Server 110 may be utilized by a particular network attack mitigation service to interface with one or more nodes 170 (e.g., one or more autonomous systems) across the internet (e.g., at the ISP level, or at any other suitable level) to quickly and efficiently propagate BGP updates or other network protocol modifications at the router level on behalf of a particular target. In this way, the system may be configured to identify and drop any malicious traffic having a destination of the target as soon as the traffic is generated from an identifiable source.

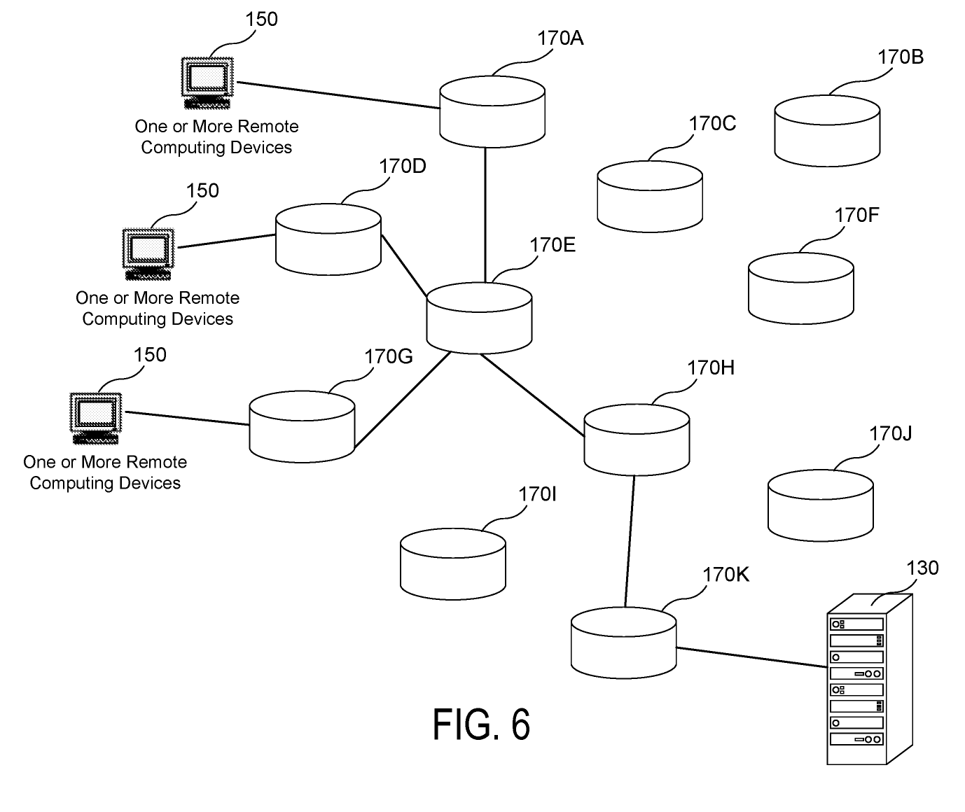

FIG. 6 depicts an exemplary network based attack from a plurality of computing devices 150, which may, for example, include a botnet or other coordinated attack against a particular target 130. As may be understood from this figure, malicious traffic from each of the One or More Remote Computing Devices 150 may take a different path to the target via one or more of a plurality of nodes 170A-K. As may be understood in light of this disclosure, because of the high number of potential paths the malicious traffic can take, implementation of network protocol modification at the local level (e.g., at the target server 130 itself) or at a few lower traffic nodes may be ineffective at mitigating a network-based attack (e.g., because each particular node or the target server 130 would still have to handle a high volume of traffic prior to dropping the traffic). As such, integrating the network protocol modification system with one or more ISPs or other backbone level internet architecture may provide greater effectiveness in handling and mitigating DDoS and other network-based attacks.

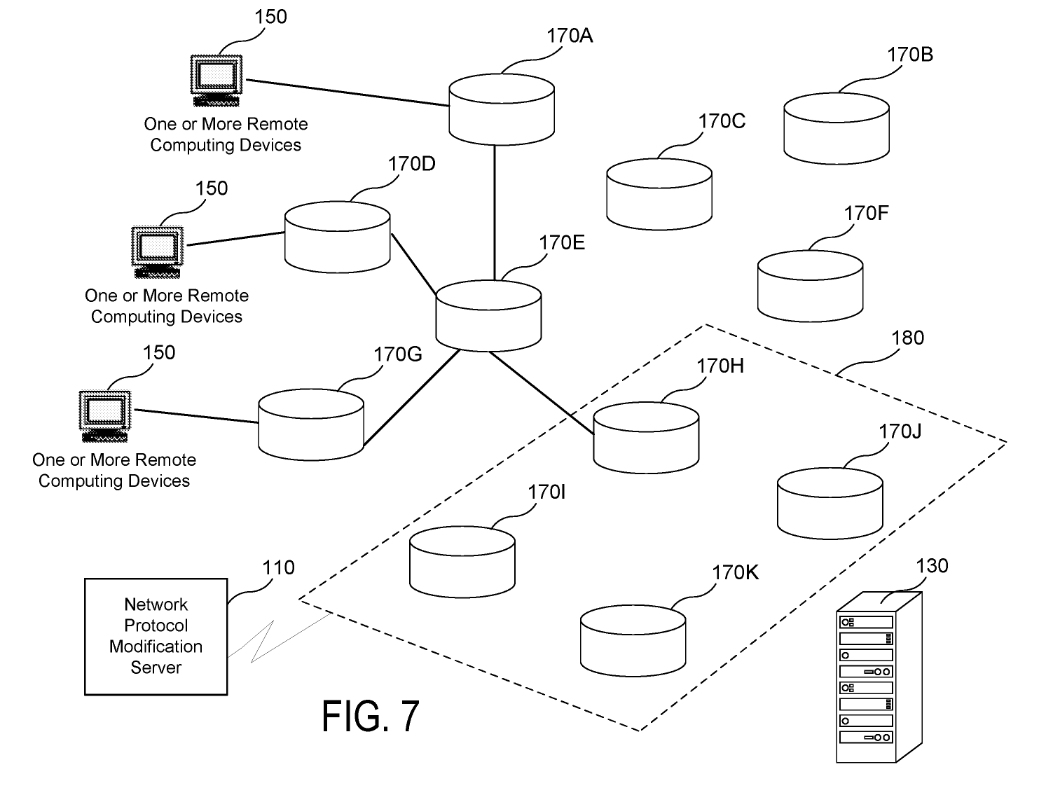

FIG. 7 depicts an exemplary implementation of the network protocol modification system against a distributed attack from a plurality of computing devices 150 as shown in FIG. 6. In the example shown in this Figure, the eighth node 170H, ninth node 170I, tenth node 170J, and eleventh node 170K may comprise a particular autonomous system (e.g., or collection of autonomous systems) that make up One or more ISP Systems 180. As shown in this Figure the Network Protocol Modification Sever 110 is in networked communication with the One or More ISP Systems 180

In particular embodiments, the Network Protocol Modification Server 110 may be configured to interface with a particular Internet Server Provider (ISP) system (e.g., the One or More ISP Systems 180) to provide, transmit, and/or propagates network protocol modification packets and/or updates that are configured to modify the handling of network traffic (e.g., internet traffic) at the ISP level. As may be understood from FIG. 7, the Network Protocol Modification Server 110 may provide a BGP update or other network protocol modification (e.g., in the form of one or more packets) to the One or More ISP Systems 180 (e.g., one or more nodes 170H-K that make up the One or More ISP Systems 180). As shown in FIG. 7, once the Network Protocol Modification Server 110 has provided the BGP update to the One or More ISP Systems 180, the One or More ISP Systems 180 drop the malicious network traffic as soon as it enters the One or More ISP Systems 180 for routing.

Although FIG. 7 depicts the One or More ISP Systems 180 as a related group of nodes, 170H-K, it should be understood that any other node shown may be part of any other suitable ISP system or other system that also is in networked communication with the Network Protocol Modification Server 110. As such, in various embodiments, the example shown in FIG. 7 may include a plurality of nodes 170A-K, all of which have applied a BGP update provided by the Network Protocol Modification Server 110 that drops all traffic having a source identified as a source of the network-based attack.

### Exemplary Content Filtering Via BGP Modification

Although the network protocol modification system is generally described above in the context of mitigating network-based attacks, it should be understood in light of this disclosure that one or more of the techniques described herein may be utilized in the modification of one or more network protocols to affect the handling of any other suitable type of network traffic. As a particular example, the system may be implemented (e.g., at the ISP level) to filter copyrighted and other desired content.

Currently, rights-holders may rely on the Digital Millennium Copyright Act (DMCA) in order to request companies, content-hosts, ISPs and others to takedown copyrighted content once it is identified. Under the DMCA, rights-holders can only request take downs after content has actually been uploaded and identified. Rights-holders may desire more straightforward ways of protecting their copyrighted content before it is made available on the internet without their authorization.

In various embodiments, the system may be configured to determine a particular source of illegal copyrighted content. The system may do this in a manner similar to the manner in which the system identifies a source of network-based attacks described above. The system may, for example, identify one or more IP addresses, networks, ISPs, etc. that are frequent violators of copyrights and add those sources to a blacklist. For example, if a particular webhost in Russia is providing copyrighted content for download, a rights-holder may prefer to filter content from the Russian host in the United States or other location where their copyright is enforceable, rather than relying on issuing takedown notices to search engines and other sites that provide links to the content in the U.S. The system may be configured to identify one or more network addresses associated with the Russian host, and, via the interface with one or more ISP systems, distribute a BGP update that drops traffic from the Russian host that has a destination IP address in the United States (e.g., or other location where they hold the copyright).

Such a solution may, for example, be beneficial for both rights holders and Internet Service Providers and other content providers, who may desire to avoid having to respond to the high volume of DMCA requests that they are currently responsible for fielding.

In another example, a particular user, group of users, etc. may frequently violate various rights-holders' copyrights by uploading copyrighted content to file sharing and other websites. In this example, the system may be configured to transmit a BGP update to one or more ISP systems that cause the one or more ISP systems to substantially automatically drop traffic from the particular user or group of users that is destined for any file sharing, file hosting, or similar other domain.

### CONCLUSION

Various embodiments may include additional features beyond those described above. Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. It should also be specifically understood that any steps executed within a set of computer-executable instructions would, at least in various embodiments, be executed by at least one computer processor associated with memory. Although specific terms are employed herein, they are used in a generic and descriptive sense only and not for the purposes of limitation.

What is claimed is:

1. A network protocol modification system comprising one or more computing devices implementing a network-based attack mitigation service, each of the one or more computing devices comprising at least one computer processor and memory, wherein the network protocol modification system is configured for:
monitoring network traffic at a target server;
detecting, based at least in part on the network traffic, a network attack on the particular target server, wherein the network attack is directed to a combination of network addresses utilized by the target server;
identifying one or more sources of the network attack, the one or more sources having one or more source network addresses; and
modifying routing of network transmissions from the one or more sources to the target server by:
generating at least one network protocol modification packet based at least in part on the network attack; and
transmitting the at least one network protocol modification packet to at least one router in communication with at least one of the one or more computing devices.

2. The network protocol modification system of claim 1, wherein the at least one network protocol modification packet comprises a Border Gateway Protocol (BGP) packet.

3. The network protocol modification system of claim 1, wherein generating the at least one network protocol modification packet comprises:
changing one or more path attributes between the one or more source network addresses and the combination of network addresses utilized by the target server; and
generating the BGP packet to include a BGP update message including the changed one or more path attributes for communication to the at least one router.

4. The network protocol modification system of claim 3, wherein changing the one or more path attributes comprises dropping the network transmissions from the one or more sources to the target server.

5. The network protocol modification system of claim 1, further comprising transmitting the at least one network protocol modification packet to at least one external BGP neighbor to a router associated with the target server.

6. The network protocol modification system of claim 1, wherein:
the at least one router in communication with the at least one of the one or more computing devices is associated with a first autonomous system (AS) associated with a first Internet Service Provider (ISP).

7. The network protocol modification system of claim 6, wherein the network protocol modification system is further configured for:
generating a communication channel between the at least one of the one or more computing devices and the first AS; and
transmitting the at least one network protocol modification packet to the at least one router via the communication channel.

8. The network protocol modification system of claim 6, wherein the network protocol modification system is further configured for:
transmitting the at least one network protocol modification packet to a plurality of routers, wherein:
each of the plurality of routers is associated with a respective ISP of a plurality of ISPs; and
each of the plurality of routers is in communication with one or more particular computing devices of the one or more computing devices.

9. The network protocol modification system of claim 8, wherein the network protocol modification system is further configured for transmitting the at least one network protocol modification packet to the plurality of routers via a respective communication channel.

10. A computer-implemented network routing protocol modification method comprising:
detecting, by a network protocol modification system comprising one or more processors, a network attack on one or more computing devices, the network attack being directed to a combination of network addresses utilized by the one or more computing devices;
identifying, by a network protocol modification system comprising one or more processors, based at least in part on the network attack, one or more source network addresses that are a source of the network attack;
providing, by one or more processors, a networked communications link between the network protocol modification system and an Internet Service Provider (ISP) system, the ISP system comprising an autonomous system (AS) comprising at least one node; and
mitigating the network attack, by a network protocol modification system comprising one or more processors, by:
generating a BGP packet configured to modify how data addressed to the combination of network addresses is routed, the BGP packet defining routing instructions for malicious network traffic originating from the one or more source network addresses and having a destination address of one of the combination of network addresses utilized by the one or more computing devices; and
transmitting the BGP packet to the autonomous system (AS) via the networked communications link, wherein
the routing instructions comprise an instruction to drop the malicious network traffic.

11. The computer-implemented network routing protocol modification method of claim 10, wherein the network attack comprises a distributed denial of service (DDoS) attack.

12. The computer-implemented network routing protocol modification method of claim 10, wherein mitigating the network attack comprises transmitting the BGP packet to the at least one node via the networked communications link.

13. The computer-implemented network routing protocol modification method of claim 10, wherein the instruction to drop the network traffic comprises an instruction to send the malicious network traffic to a local host.

14. The computer-implemented network routing protocol modification method of claim 10, wherein:
the ISP system is a first ISP system;
the autonomous system (AS) is a first AS;
the at least one node is at least one first node;
the networked communications link is a first networked communications link; and
the method further comprises:
providing, by one or more processors, a second networked communications link between the network protocol modification system and a second Internet Service Provider (ISP) system, the second ISP system comprising a second autonomous system (AS) comprising at least one second node; and
mitigating the network attack, by a network protocol modification system comprising one or more processors, by transmitting the BGP packet to the second autonomous system (AS) via the second networked communications link.

15. The computer-implemented network routing protocol modification method of claim 10, wherein:
the at least one second node comprises a first router;
the second AS comprises a second router; and
mitigating the network attack further comprises transmitting the BGP packet to the first router and the second router.

16. A network protocol modification system comprising one or more computing devices implementing a network-based network routing protocol modification service, each of the one or more computing devices comprising at least one computer processor and memory, wherein the network protocol modification system is configured for:
identifying one or more sources of unwanted network traffic, the one or more sources having one or more source network addresses;
providing a networked communications link between the network protocol modification system and an Internet Service Provider (ISP) system, the ISP system comprising an autonomous system (AS) comprising at least one node; and
modifying routing of network transmissions from the one or more source network addresses to one or more destination network addresses by:
generating at least one network protocol modification packet based at least in part on the unwanted network traffic, the at least one network protocol modification packet defining routing instructions for the unwanted traffic between the one or more source network addresses and the one or more destination network addresses; and
transmitting the at least one network protocol modification packet to the AS via the networked communications link for configuration of the at least one node, wherein:
the routing instructions comprise an instruction to drop the unwanted traffic.

17. The network protocol modification system of claim 16, wherein:
the one or more sources of unwanted traffic comprise one or more host servers; and
the unwanted traffic comprises one or more pieces of copyrighted data.

18. The network protocol modification system of claim 16, wherein the unwanted traffic comprises a distributed denial of service (DDos) attack.

19. The network protocol modification system of claim 16, wherein the network protocol modification system is further configured for:
providing a respective networked communications link between the network protocol modification system and each of a plurality of Internet Service Provider (ISP) systems, each of the ISP systems comprising a respective autonomous system (AS) comprising at least one respective node; and
transmitting the at least one network protocol modification packet to each respective AS via the respective networked communications link for configuration of the each at least one respective node.

20. The network protocol modification system of claim 19, wherein the one or more destination network addresses comprise one or more destination network addresses in a particular geographical area.
